(19) United States
(12) Patent Application Publication
(10) Pub. No.: US 2022/0381010 A1
(43) Pub. Date: Dec. 1, 2022

(54) METHODS AND SYSTEMS FOR THE AUTOMATIC MANAGEMENT OF WASTEWATER AND FRESHWATER FOR RECREATIONAL VEHICLES

(71) Applicant: PPO Innovations Ltd, London (GB)

(72) Inventor: Matthew Hooper, Margate, FL (US)

(21) Appl. No.: 17/825,291

(22) Filed: May 26, 2022

Related U.S. Application Data
(60) Provisional application No. 63/193,353, filed on May 26, 2021.

(51) Int. Cl. E03B 1/04; E03B 11/02; E03B 7/07; E03B 7/08

(52) U.S. Cl. CPC E03B 1/041; E03B 11/02; E03B 7/078; E03B 7/08; E03B 2001/045

(57) ABSTRACT

A system for the automatic management of the wastewater and freshwater for recreational vehicles is disclosed. The system includes a plurality of sensors configured for monitoring a first volume of blackwater within a blackwater holding tank, a second volume of greywater within a greywater holding tank, and whether an egress conduit is attached to a sewage system. The system further includes a processor configured for receiving a plurality of first signals from the plurality of sensors and sending a plurality of second signals to at least one of a plurality of values within the system. The processor is configured for determining if the first volume and second volume exceeds a first predetermined maximum threshold and a second predetermined maximum threshold respectively, then transmitting one of the plurality of second signals to prevent matter and wastewater from entering at least one of the blackwater holding tank and greywater holding tank.

### CROSS-REFERENCE TO RELATED APPLICATIONS

This application claims the benefit of the filing date of U.S. Provisional Application Ser. No. 63/193,353 titled “METHODS AND SYSTEMS FOR THE AUTOMATIC MANAGEMENT OF WASTEWATER AND FRESHWATER FOR RECREATIONAL VEHICLES” and filed May 26, 2021, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of recreational vehicle wastewater management, and more specifically to the field of automatic recreational vehicle wastewater management.

### BACKGROUND

Recreational vehicles typically contain different tanks to facilitate the storage, flushing, and contents disposal of freshwater, wastewater, and unwanted solid waste products. Operators of recreational vehicles depend upon these tanks and systems to utilize these vehicles in a self-sufficient manner and maintain comfortable accommodations and suitable living quarters.

The proper filling, storage, flushing, and disposal of the tanks' contents and associated hoses is necessary to circumvent substantial hygienic and environmental safety concerns. Recreational vehicles separate fresh water and wastewater, in some instances utilizing separate tanks for black water and grey water, and the proper disposal of these tanks' contents not only is paramount to the safety of the recreational vehicle operator, but to others in the surrounding environment as well. Waste contents from black water and grey water tanks constitute significant safety hazards to all persons unless the tanks are properly flushed, and its contents are properly disposed.

Problems with the emptying of black water and grey water tanks include the buildup of solid waste materials that do not easily exit from the tanks. For example, when such waste materials buildup within the tanks, there is great difficulty in disposing those waste materials because this waste does not flow easily through the disposal system of hoses, which can also lead to clogged valves and hoses. Such buildup of solid waste materials within tanks can cause the tanks to overflow, causing raw wastewater and solid waste materials to spew and spill out. In addition, the buildup of waste materials releases odors and fumes, which can cause great discomfort, unpleasantness, and inhabitability within the small living quarters of a recreational vehicle. Furthermore, such waste material buildup results in more frequent required disposal of the tank contents at designated waste dumping or removal sites, diminishing the self-sufficiency of the recreational vehicle due to increased downtime when emptying the tanks' contents.

To remove waste materials from the tanks, a recreational vehicle operator must connect hoses both to the designated system within the recreational vehicle and an external hookup at a designated waste disposal site. However, failure to properly secure these hoses to the external hookup and to the recreational vehicle can lead to waste materials from the black water and grey water tank oozing onto the ground, surrounding area around the disposal site, and even onto nearby persons. Such wastewater and solid waste material leakage and dumping constitutes significant safety issues and health hazards for those in the vicinity, with a pressing need to properly remediate the waste materials.

As a result, there exists a need for improvements over the prior art and more particularly for a more hygienic, more efficient, safer, and smarter approach to systems that manage freshwater, black water, and grey water tanks for recreational vehicles.

### SUMMARY

A system and method for the automatic management of wastewater and freshwater for recreational vehicles is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for the automatic management of the wastewater and freshwater for recreational vehicles is disclosed. The system comprises a blackwater holding tank having a blackwater inlet, and a blackwater egress and a greywater holding tank having a greywater inlet, and a greywater egress. The system further includes a blackwater sensor and a greywater sensor. The blackwater sensor is configured for monitoring a first volume of blackwater within the blackwater holding tank and the greywater sensor is configured for monitoring a second volume of greywater within the greywater holding tank. The system has at least one tank entry valve in fluid communication with the blackwater inlet and greywater inlet for controlling the flow of water and matter entering the blackwater holding tank and greywater holding tank. At least one tank drain valve is in fluid communication with the blackwater egress and greywater egress for controlling the flow of water and matter leaving the blackwater tank and grey water tank. The tank drain valve is in fluid communication with an egress conduit which is removably connected to a sewer system. To monitor whether the egress conduit is attached to the sewer system, the system includes an egress conduit monitoring sensor. To facilitate the automatic management of the wastewater and freshwater, the system further includes at least one processor configured for receiving a plurality of first signals from sensors and sending a plurality of second signals to said valve. The processor is configured for determining if the first volume exceeds a first predetermined maximum threshold and if the second volume exceeds a second predetermined maximum threshold, then transmitting one of the plurality of second signals to prevent matter and wastewater from entering at least one of the blackwater holding tank and greywater holding tank. The processor is also configured for determining if the egress conduit is attached to the sewage system, then transmitting to at least one of (1) the at least one tank entry valve and (2) the at least one tank drain valves, one of the second signals to close to at least one of (a) the at least one tank entry valve and (b) the at least one tank drain valves.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 illustrates a diagram of an operating environment that supports a system for the automatic management of wastewater and freshwater for recreational vehicles, according to an example embodiment;

FIG. 2A illustrates a block diagram of components of the system for the automatic management of wastewater and freshwater for recreational vehicles, according to an example embodiment;

FIG. 2B illustrates a schematic diagram of the components of the system, namely, the sensors and valves in electrical communication with the control system and processor, according to an example embodiment;

FIG. 3A is a block diagram illustrating an exemplary method for the automatic management of wastewater and freshwater for recreational vehicles, namely, the emergency stop and initial monitoring control, according to an example embodiment;

FIG. 3B is a block diagram illustrating an exemplary method for the automatic management of wastewater and freshwater for recreational vehicles, namely, monitoring the first volume of blackwater and second volume of greywater and determining whether it exceeds predetermined thresholds, according to an example embodiment;

FIG. 3C is a block diagram illustrating an exemplary method for the automatic management of wastewater and freshwater for recreational vehicles, namely, monitoring an egress conduit and determining if it is attached to a sewer system, according to an example embodiment;

FIG. 3D is a block diagram illustrating an exemplary method for the automatic management of wastewater and freshwater for recreational vehicles, namely, executing the automatic dump function, according to an example embodiment;

FIG. 4A is a block diagram illustrating a method for the automatic management of wastewater and freshwater for recreational vehicles, according to an example embodiment;

FIG. 4B is a block diagram illustrating a method for the automatic mode, according to an example embodiment;

FIG. 4C is a block diagram illustrating a method for the manual mode, according to an example embodiment;

FIG. 5 is a side view of a holding tank having a plurality of sensors, according to an example embodiment;

FIG. 6 illustrates a graphical user interface for a display, according to an example embodiment; and

FIG. 7 illustrates a computer system according to exemplary embodiments of the present technology.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system for the automatic management of wastewater and freshwater for recreational vehicles. The system improves upon the prior art by automatically controlling the facilities and managing the wastewater within a recreational vehicle.

The systems automation improves upon the prior art by providing a safer, more hygienic operation and utilization of the wastewater and freshwater management within recreational vehicles. By automatically managing the wastewater and freshwater systems within the recreational vehicles, users reduce the risk of overfilling of onboard holding tanks, exposing others to harmful odors, and contacting with raw wastewater and solid waste. By automating the wastewater management systems, the user is able to continuously monitor the holding tanks and the volume contents of blackwater and greywater within the system. Additionally, the user is able to automatically dump the holding tanks when the processor determines that the blackwater and greywater exceed predetermined maximum thresholds and the egress conduit is attached to the sewer system. The automated system facilities content waste disposal, and flushes the greywater and blackwater holding tanks. Overall, the system improves upon the prior art by providing a system having at least one processor configured for receiving signals from a plurality of sensors continuously monitoring parameters of the system and transmitting a plurality of signals to a plurality of valves within the system to control the management of blackwater and greywater within the system.

It is understood that the prior art generally requires the blackwater holding tank, which contains fecal matter, to be manually emptied. Even if the recreational vehicle is connected to a sewage system, such as a septic tank, the drain valve of the blackwater tank and the greywater tank must remain closed. This is to ensure that harmful odors and bacteria do not contaminate clean water supply or the air within the recreational vehicle. Because the holding tanks must be manually drained, buildup of wastewater (blackwater and/or greywater) may also cause odors to remit about the recreational vehicle. As such, the system improves upon the prior art by providing an automatic dumping of the holding tanks and a cleaning function thereof. It is understood that although the system determines that the egress conduit is connected to the sewage system prior to automatic functions, the tank drain valves are normally closed until the respective predetermined maximum threshold volumes are reached. It is important that at least the blackwater tank drain valve is not always open as to prevent toxic material, waste, odor, and bacteria from entering the recreational vehicle and diminishing the air quality. In certain embodiments, the egress conduit may include a separate conduit for each of the blackwater holding tank and the greywater holding tank connected to separate sewage systems (i.e. one sewage system to receive greywater and one sewage system to receive blackwater). As such, the greywater drain valve may remain open as there is no fecal matter to contaminate the pipes, air, and clean water throughout the recreational vehicle. It is further understood that the methods described herein may be performed on each respective holding tank independently, which is ideal, and which may occur simultaneously in certain embodiments. In other embodiments, the methods may be dependent on the holding tanks, such that both holding tanks shall reach the maximum threshold prior to auto-dumping, depending on the type of sewage hookup (single egress conduit or separated conduits) and/or other regulations, such as campground specific regulations that limit dumping.

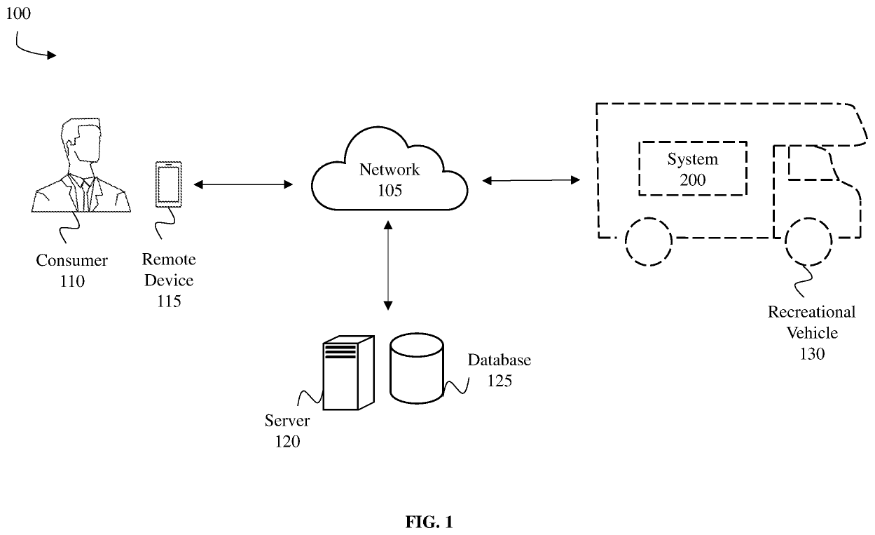

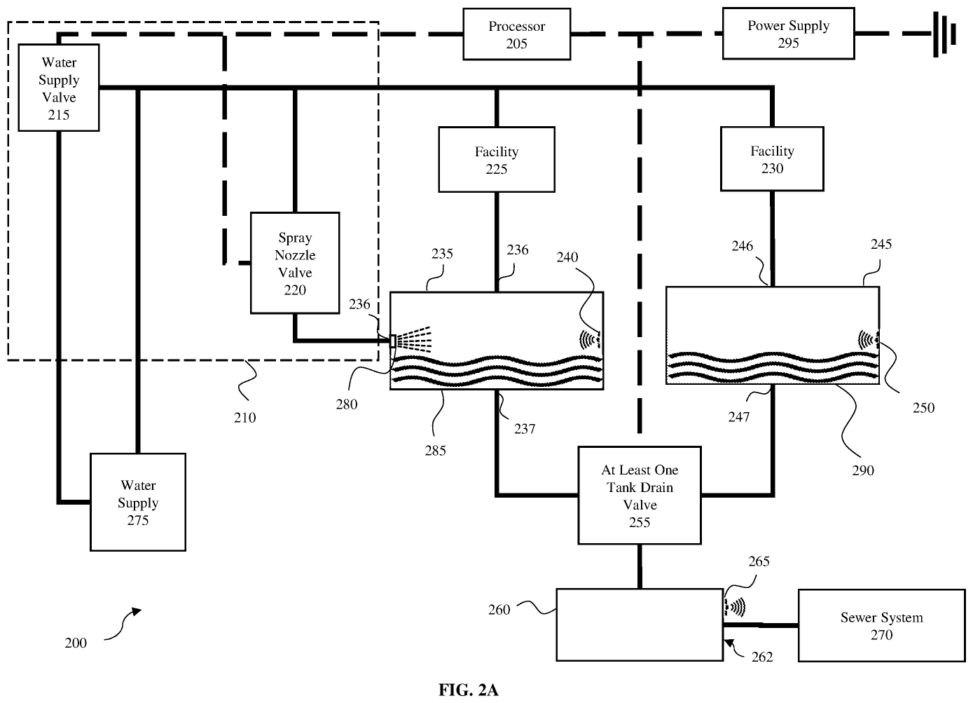

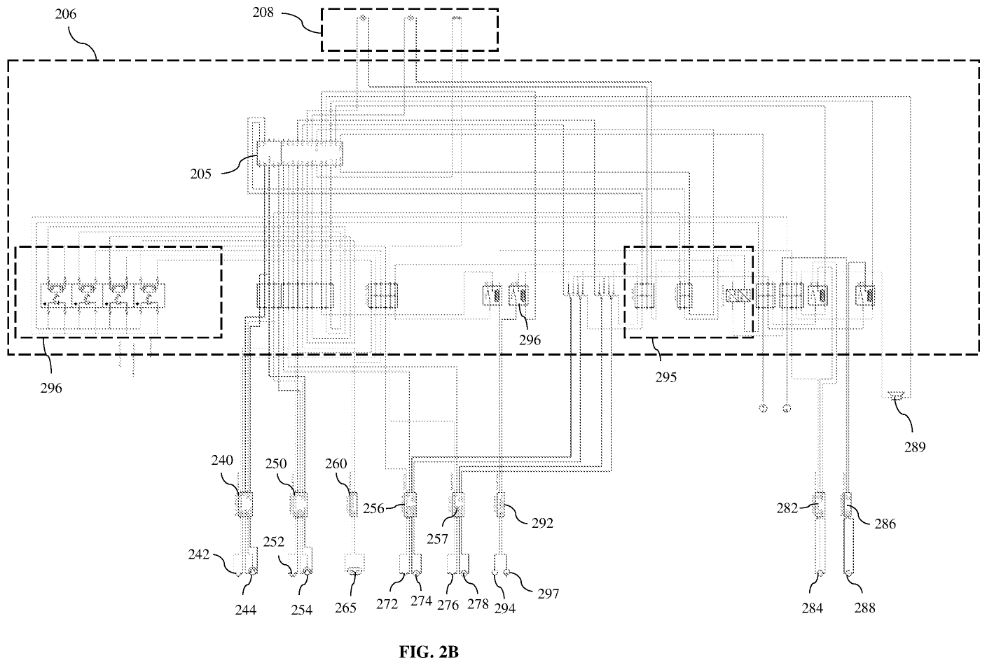

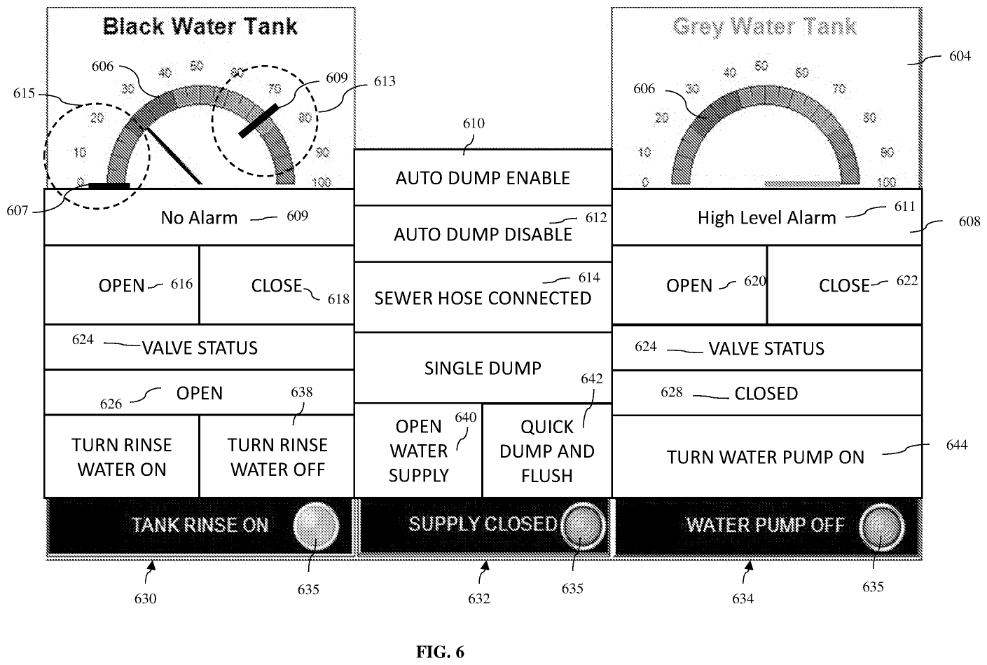

Referring now to the Figures, FIG. 1 illustrates a diagram of an operating environment 100 that supports a system 200 for the automatic management of wastewater and freshwater for recreational vehicles, according to an example embodiment. The operating environment may include a user (e.g., a consumer) 110 on a remote device 115, a network 105, at least one server 120, a database 125, a vehicle 130, and system 200. The network is in communication with the at least one server 120 and the at least one database 125. The recreational vehicle supports the system where the recreational vehicle may include recreational vehicles such as motorhomes, campervans, caravans, fifth-wheel trailers, popup campers, truck campers, airplanes, automobiles, buses, boats, yachts, and other vehicles equipped with living facilities designed for accommodation. The operating environment shows the consumer on the remote device where the remote device is configured to interact with the system via the network. The system is configured to receive a third signal from the remote device such that the third signal is configured to cause at least one processor of the system to transmit at least one of a plurality of second signals within the spirit and scope of this disclosure. The remote device may include remote devices such as remote computing devices, voice activated remote controlling devices, programmable logic controllers, smart home systems, cellular phones, and other remotes devices configured for sending signals for controlling apparatus and systems. A smart home system may include systems such as those to allow the owners of a recreational vehicle to integrate controls of other appliances and existing devices remotely using a smartphone or tablet. The smart home system may include a display and may further include voice activated and voice control functions. For example, the smart home systems may integrate with Amazon Alexa®, Google Assistant®, Apple Siri® and Microsoft Cortana® systems for example. For example, a smart home system may transmit, to the control system of the present device, data corresponding to a voice command, such as the user saying “QUICK DUMP AND FLUSH”. Such command may also be an input button on a graphical user interface of the display, such as shown in FIG. 6. The at least one processor of the control system will process said data and may execute the corresponding methods described herein. A programmable logic controller is a computing device, having at least one processor, adapted for the control of manufacturing and/or system processes, such as assembly lines, machines, robotic devices, or any activity that requires high reliability, ease of programming, and process fault diagnosis. The control system of FIG. 2B illustrates an example control system defined by a programmable logic controller, namely, processor 205.

Referring now to FIGS. 2A and 2B, a block diagram of components of the system 200 for the automatic management of wastewater and freshwater for recreational vehicles is shown, according to an example embodiment. The system is configured for automatically controlling the wastewater, including the blackwater and greywater, within the system. Therefore, the system includes at least one processor 205 in electrical communication with a power supply 295. Electrical communication is represented between the components of the system as illustrated in FIG. 2 by a bolded dotted line. As illustrated, the processor 205 is in further electrical communication with a plurality of valves. The plurality of valves within the system includes at least one tank entry valve 210 and at least one tank drain valve 255. In certain embodiments, the tank entry valve may comprise a pump in fluid communication with the water supply configured to pump water from the water supply, which may be utility water or a fresh water holding tank, throughout the system, such as to the spray nozzles and rinse control units. Fluid communication means that the components of the system 200 may be connected via a plumbing system, including a plurality of pipes and tubes, such as polyvinyl chloride pipes such that fluid can flow between the components of the system via the plumbing system.

The at least one tank entry valve is in fluid communication with a blackwater inlet 236 and a greywater inlet 246 for controlling a flow of water and matter entering a blackwater holding tank 235 and a greywater holding tank 245. The system includes the blackwater holding tank 235 where the blackwater holding tank has the blackwater inlet 236 and a blackwater egress 237. Similarly, the system includes the greywater holding tank 245 having a greywater inlet 246 and a greywater egress 247. When water and matter enter the blackwater holding tank and the greywater holding tank, the water and matter define the blackwater 285 and greywater 290, respectively. The at least one tank drain valve is in fluid communication with the blackwater egress and the greywater egress for controlling the flow of water and matter, or blackwater and greywater, leaving the blackwater holding tank and greywater holding tank, respectively. The at least one tank drain valve is in fluid communication with the blackwater egress and the greywater egress for controlling the flow of water and matter leaving the blackwater holding tank and greywater holding tank. In one example embodiment, the at least one tank entry valve includes a water supply valve 215 and a spray nozzle valve 220. Fluid communication between the components of the system is illustrated by the solid black lines as illustrated in FIG. 2.

The at least one processor is configured for receiving a plurality of first signals from a plurality of sensors within the system. In an example embodiment, the at least one processor is configured for receiving a plurality of first signals from a blackwater sensor 240, a greywater sensor 250, and an egress conduit sensor 265. The blackwater sensor is configured for monitoring a first volume of blackwater within the blackwater holding tank. The greywater sensor is configured for monitoring a second volume of greywater within the greywater holding tank. The greywater sensor and blackwater sensor are float sensors measures the level of liquid in the holding tank. The float sensors are continuous level sensors featuring a magnetic float that rises and falls as liquid levels change. The movement of the magnetic float creates a magnetic field that actuates a hermetically sealed reed switch located in the stem of the level sensor, triggering the switch to open or close. Different variations of float switches may be used depending on the type of fluid within the holding tank. Both of the greywater holding tank and the blackwater holding tanks may also include a high level float sensors, which check if the liquid level rises to a certain level. Both the float sensors and the high level float sensors are installed through the top of the holding tanks, in which a small opening is made to install them together. The existing level sensors are not interfered with so any existing monitoring system will operate as normal. The blackwater sensor is in attachment with the blackwater holding tank such that the blackwater sensor can monitor the first volume of blackwater. In one embodiment, the blackwater sensor is attached to the interior of the blackwater holding tank. Likewise, the greywater sensor is in attachment with the greywater holding tank such that the greywater sensor can monitor the second volume of greywater. In one embodiment, the greywater sensor is attached to the interior of the greywater holding tank.

The system further includes an egress conduit 260 in fluid communication with the at least one drain tank and is removably connected with a sewer system. The egress conduit is a hose or channel, such as an elbow fitting, that facilitates the drainage of wastewater from the holding tanks to the sewage system. For example, an elbow fitting is connected to an inlet of the dump station, or sewer system, and directs the wastewater into the septic tank, much like a funnel. The egress conduit sensor may be disposed be on the elbow fitting to monitor whether a hose of the sewer system is connected to the egress conduit. In other embodiments, the egress conduit sensor may be disposed at an end of the hose, such as the connection point as to monitor whether the hose is connected to the sewer system. The sewer system may be a utility sewage connection or an external sewage containment that is not connected to the recreational vehicle, such as a septic tank. The egress conduit may attach directly to the sewage system or septic tank. In other embodiments, the sewer system may include a hose or pipe to connect to the egress conduit.

In attachment with the egress conduit is the egress conduit sensor. In one example embodiment, the egress conduit sensor is attached to the exterior of the egress conduit. The egress conduit sensor is configured for monitoring whether the egress conduit is attached to the sewer system. In one example embodiment, the egress conduit sensor is a magnetic contact sensor which monitors when the sewer system is connected and contacts the egress conduit. In other embodiments, the at least one tank drain valve is two tank drain valves, each connected to the blackwater holding tank and greywater holding tank, respectively, and in fluid communication with the egress conduit. In other embodiments, the egress conduit sensor is a microswitch pressed by a flange of a sewage hose when the conduit is connected to the drain outlet.

The at least one processor is further configured for transmitting a plurality of second signals to the at least one tank entry valve and the at least one tank drain valve. The at least one tank entry valve and the at least one tank drain valve are in electrical communication with the at least one processor such that at least one tank entry valve and the at least one tank drain valve are configured for receiving at least one of the plurality of second signals transmitted from the at least one processor. The at least one tank entry valve may include one of a magnetic solenoid and an electric ball valve and the least one tank drain valve includes a linear type actuator. The at least one tank entry valve may include the solenoid such that when the at least one tank entry valve receives one of the plurality of second signals from the at least one processor, where such second signal is a current, then the current will pass a coil generating an electromagnetic field. Within the at least one tank entry valve is an armature where the solenoid may surround the armature at the center of its magnetic field. The armature having a plunger and a spring configured to close said valve when no current passes through the coil by having the plunger apply a compression force on the spring. However, when a current passes through the coil, the generated electromagnetic field forces the plunger away from the spring such that the spring is relaxed, and therefore the tank entry valve opens. The electric ball valve will shut off the water supply to the RV in case of over filling of a waste water in the facility. The linear type actuator that is an electric actuator that creates motion in a straight line, in contrast to the circular motion of a conventional electric motor. The linear type actuator opens and closes the tank drain valve depending on the signal received by the control system.

The system may include a water supply 275 in fluid communication with at least one of the blackwater holding tank and greywater holding tank. The water supply can include either a direct utility water supply from a recreational vehicle water hookup, a hose, or a stored water supply holding tank. In other embodiments, the water supply is connected to at least one pump such that the pump can supply freshwater throughout the system to the facilities and/or the spray nozzles. As illustrated in the FIG. 2 example embodiment, the at least one tank entry valve includes a water supply valve 215 and a spray nozzle valve 220. The water supply valve is in fluid communication with the water supply and is configured for controlling the water from the water supply into at least one of the blackwater holding tank and the greywater holding tank. The spray nozzle valve is in fluid communication with the water supply and an at least one spray nozzle 280 configured for controlling the high pressurized water spraying from the at least one spray nozzle. The at least one spray nozzle is disposed within at least one of the blackwater holding tank and the greywater holding tank, where the at least one spray nozzle is in fluid communication with the water supply. In an ideal embodiment, the spray nozzle is installed in the top of at least one of the blackwater holding tank and the greywater holding tank to wash down the sensors. In other embodiments, the spray nozzle may be installed in other interior sides of the holding tanks. The at least one spray nozzle is configured for spraying high pressurized water into at least one of the blackwater holding tank and greywater holding tank. The at least one spray nozzle sprays water on and within the blackwater holding tank and grey water holding tank to clean the walls of the blackwater holding tank and greywater holding tank. The spray nozzle assists the system with the removal of blackwater and greywater, as the blackwater and greywater exits the blackwater holding tank and greywater holding tank through the blackwater egress and greywater egress, respectively.

In an example embodiment, the blackwater holding tank and greywater holding tank may be connected to a facility 225, 230 such as a toilet, sink, shower, dishwasher, washer machining, or other appliance. Such facilities, 225 and 230, may include drain valves or other valves to allow waste water and waste materials (such as fecal matter, urine, dirt, unclean water, etc.) to enter the respective valve. Generally, the toilet is in fluid communication with the blackwater holding tank to allow fecal matter and other waste products to enter the blackwater holding tank and the showers and sinks are generally in fluid communication with the greywater holding tank. Accordingly, all fecal matter is held within the blackwater holding tank. In some embodiments, the greywater holding tank and blackwater holding tank may be connected to the same facility. For example, a sink having two drains may be connected to both a blackwater holding tank and a greywater holding tank. Ideally, the blackwater holding tank will be connected to facility 225 including a toilet whereas the greywater holding tank will be connected to facility 230 including a shower for example. Other embodiments within the spirt and scope of the disclosure may exist.

Referring specifically to FIG. 2B, a schematic diagram of the components of the system, namely the control system 206, plurality of sensors, and plurality of valves, is shown according to an example embodiment. All the component illustrated in FIG. 2B are in electrical communication with each other. The control system includes a processor 205, a plurality of switches, and a power supply 295. The power supply may be a battery within the control system or a connector to an exterior battery, such was plug to another power source. The control system is in electrical communication with the display of the remote device. The display of the remote device includes a graphical user interface that has a plurality of user interface elements configured to allow the user to interact with the control system 206. The plurality of switches 296 includes a plurality of relays, each of which switches one or more poles. The contacts of the poles can be thrown by energizing the coil within the relay. When the switch is activated, electric signals may pass through the switch. However, when the switch is deactivated, electric signals may not pass through the switch. The system may include physical buttons on a remote device or graphical buttons on the display 208 of a remote device that controls the activation of the switches. The plurality of sensors includes blackwater sensors 240, greywater sensors 250, and an egress conduit sensor 265 that is for the egress conduit 260. The blackwater sensor include both a high level float sensor 242 and a float sensor 244. The greywater sensors include both a high level float sensor 252 and a float sensor 254.

The plurality of valves includes the blackwater valve 256 and the greywater valve 257. The blackwater valve includes the blackwater valve sensor 272 and blackwater valve control 274. The blackwater valve sensor detects whether the blackwater valve is open or not and the blackwater valve control is the linear type actuator that opens and closes the blackwater valve. The greywater valve includes the greywater valve sensor 276 and greywater valve control 278. The greywater valve sensor detects whether the greywater valve is open or not and the greywater valve control is the linear type actuator that opens and closes the greywater valve. The plurality of valves further includes water supply valve 282 that is controlled by the water supply valve control 284. The water supply valve control is the electric ball valve that opens or closes the water supply valve. The spray nozzle 286 is also in electrical communication with the control system and is controlled by the magnetic solenoid 288. The magnetic solenoid allows for variation in waterflow through the spray nozzle. The system may further includes an alarm buzzer 289 that is configured to emit a sound that alerts a user of the system 200 that the holding tanks have reached a predetermined maximum threshold volume of fluid. The water pump 292 provides waterflow through the system and includes a water pump control signal and a water pump engaged signal. The water pump control signal 297 allows the user of the system to activate or deactivate the water pump. The water pump engaged signal 294 notifies the control system that the water pump is activated.

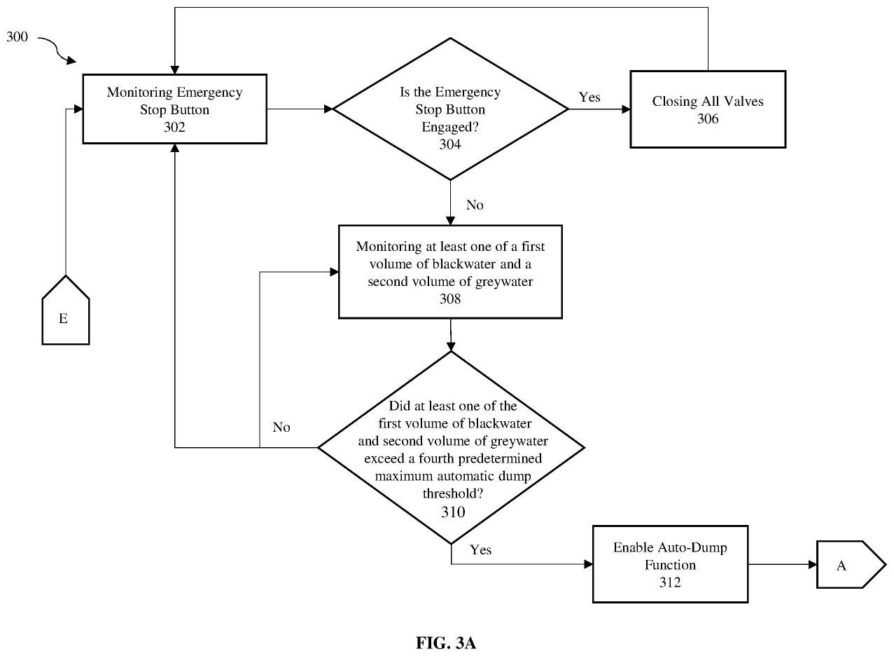

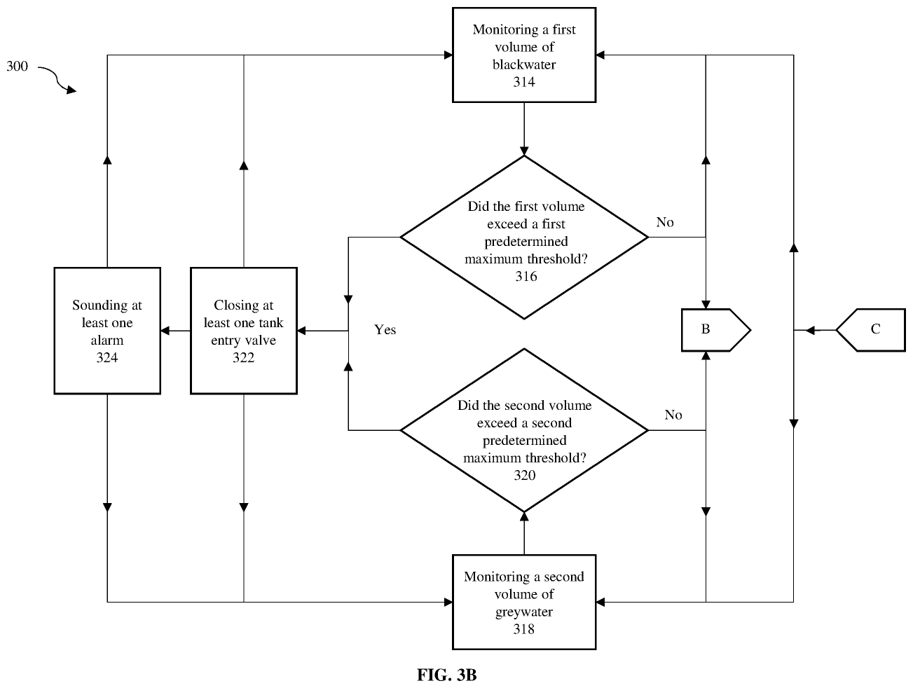

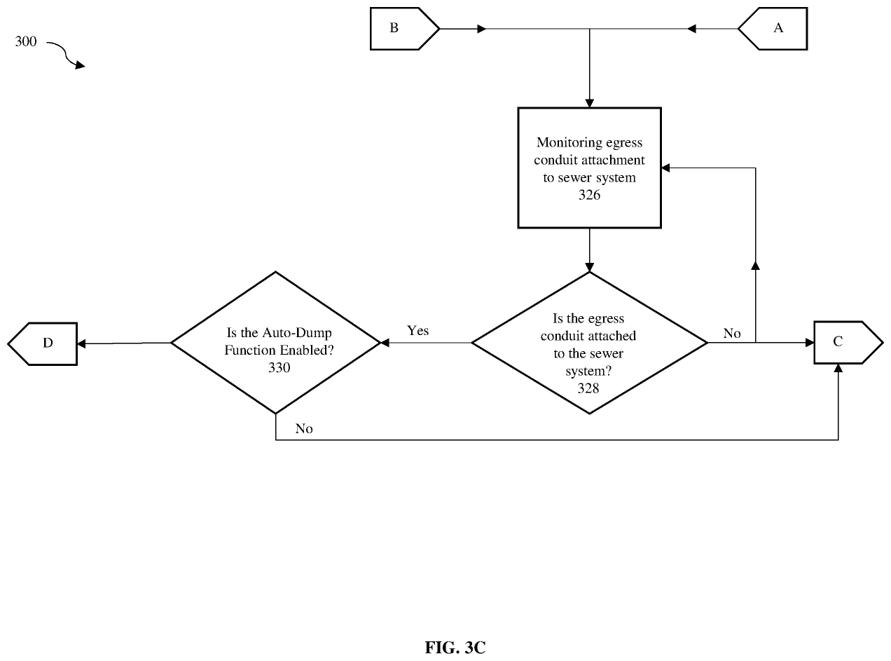

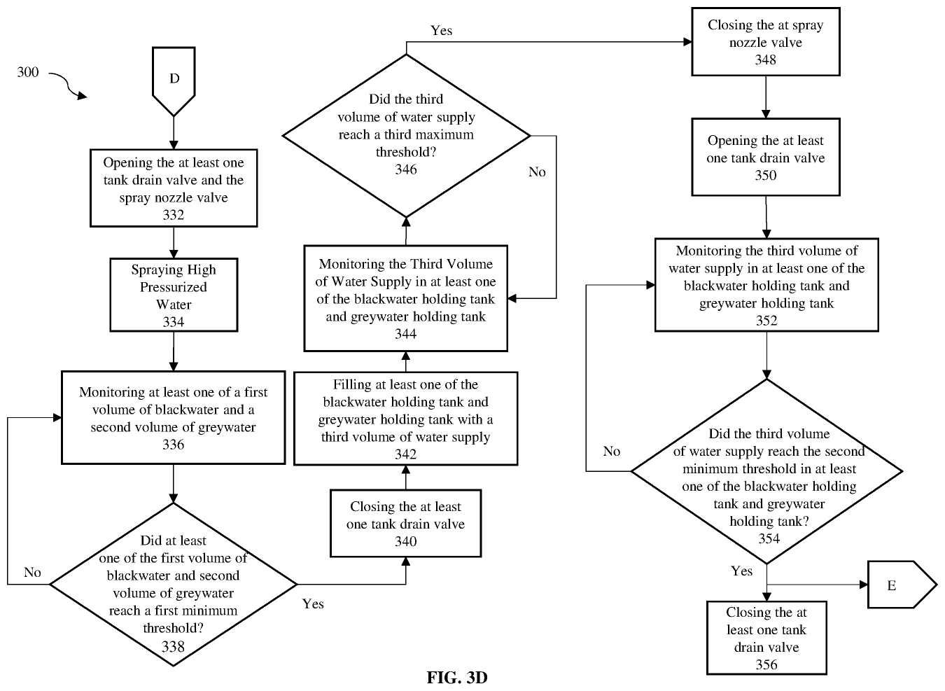

FIGS. 3A-3D illustrate an exemplary method 300 for the automatic management of wastewater and freshwater for recreational vehicles. The methods performed as diagramed in FIGS. 3A-3D may be executed by system 200 and the performed by at least one processor 205 in communication with the plurality of sensors, including the blackwater sensor 240, greywater sensor 250, and egress conduit sensor 265.

The at least one processor is configured for determining if the first volume of blackwater exceeds a first predetermined maximum threshold and if the second volume of greywater exceeds a second predetermined maximum threshold. The predetermines maximum thresholds are defined by the user of the system 200. The first predetermined maximum threshold and second predetermined maximum threshold may correspond to the percentage of total volume for each of the blackwater holding tank and greywater holding tank. In one embodiment, the user may input using the remote device the first predetermined maximum threshold and second predetermined maximum threshold and transmit the third signal to the at least one processor. The at least one processor may then set the first predetermined maximum threshold and second predetermined maximum threshold to the corresponding percentages, for example, seventy-five percent (75%) of the total volume of each of the blackwater holding tank and greywater holding tank. Therefore, as each of the blackwater sensor and greywater sensor monitors the blackwater and greywater, respectively, the at least one processor will determine whether the first volume of blackwater exceeds the first predetermined maximum threshold at seventy-five percent (75%) of the total volume of the blackwater holding tank and whether the second volume of greywater exceeds the second predetermined maximum threshold at seventy-five percent (75%) of the total volume of the greywater holding tank. It is understood that the maximum threshold volume of the holding tanks may include a tolerance of at most +/−5% volume of the respective holding tank.

When the at least one processor determines that at least one of the first volume of blackwater exceeds the first predetermined maximum threshold and the second volume of greywater exceeds the second predetermined maximum threshold, then the processor is configured for transmitting one of the plurality of second signals to the at least one tank entry valve. The processor transmits one of the plurality of second signals to the at least one tank entry valve such that one of the plurality of second signals is configured to prevent matter, wastewater, and water supply, which may define each of the blackwater and greywater, from entering at least one of the blackwater holding tank and greywater holding tank. In one embodiment, the at least one tank entry valve is connected between the facility 225 and the blackwater holding tank, where the facility is a toilet and when the at least one processor transmits one of the plurality of second signals to close the at least one tank entry valve, the toilet is unable to allow new matter, wastewater, or freshwater, to enter into the blackwater holding tank.

As the egress conduit sensor monitors whether the egress conduit is attached to the sewer system, the at least one processor is further configured for determining whether the egress conduit is attached to the sewage system based on the data received from the egress conduit sensor. When the at least one processor determines that the egress conduit is not attached to the sewage system, the at least one processor is configured for transmitting one of the plurality of second signals to at least one of the at least one tank entry valve and the at least one tank drain valve to close at least one of the at least one tank entry valve and at least one tank drain valve respectively.

Referring now to FIG. 3A, a block diagram illustrating the exemplary method 300 for the automatic management of wastewater and freshwater for recreational vehicles, namely, the emergency stop function and initial monitoring step is shown, according to an example embodiment. In one example embodiment, the system includes an emergency stop button to shut down all functions of the system. Monitoring 302 the stop button is a continuous function performed by the system, and in an example embodiment, monitoring 302 may occur through the use of at least one sensor in communication with the at least one processor. If the at least one processor determines that the emergency stop button is engaged 304, then the at least one processor will transmit a plurality of second signals to close 306 the plurality of valves within the system. The emergency stop button is engaged if the user (consumer 110 in FIG. 1) uses the remote (115 in FIG. 1) to click an emergency stop button and transmit a third signal to the at least one processor. In another embodiment, the emergency stop button may be a physical button electrically attached to the system to communicate with the at least one processor when pressed or switched. If the emergency stop button is not engaged 304, then the at least one processor will monitor 308 at least one of the first volume of blackwater and the second volume of greywater. If the at least one processor determines 310 that that at least one of the first volume of blackwater and the second volume of greywater exceed a fourth predetermined automatic dump threshold then the at least one processor will enable 312 the automatic dump function. The fourth predetermined automatic dump threshold may be the same as at least one of the first predetermined maximum threshold and the first predetermined maximum threshold, in an example embodiment, or it may consist of another parameter configured from monitoring the levels of blackwater and greywater in each of the blackwater holding tank and greywater holding tank, respectively, in another embodiment. In another embodiment, the fourth predetermined automatic threshold may include determining that the egress conduit is attached to the sewer system. After the automatic dumping function is enabled, monitoring (326 in FIG. 3C) the egress conduit attachment to the sewer.

Referring now to FIG. 3B, a block diagram illustrating the exemplary method 300 for the automatic management of wastewater and freshwater for recreational vehicles, namely, monitoring the first volume of blackwater and second volume of greywater and determining whether it exceeds predetermined thresholds, according to an example embodiment. The blackwater sensor is configured for monitoring 314 the first volume of blackwater within the blackwater holding tank. The blackwater sensor monitors the first volume of blackwater and continuously transmits one of the plurality of first signals to the at least one processor. The at least one processor receives one of the plurality of first signals from the blackwater sensor and if the at least one processor determines 316 that the first volume of blackwater exceeds the first predetermined maximum threshold, then the at least one processor transmits 322 at least one of the plurality of second signals to the at least one tank entry valves to close the at least one tank entry valve. The greywater sensor is configured for monitoring 318 the second volume of greywater within the greywater holding tank and continuously transmits one of the plurality of first signals to the at least one processor. The at least one processor receives one of the plurality of first signals from the greywater sensor and if the at least one processor determines 320 that the second volume of greywater exceeds the second predetermined maximum threshold, then the at least one processor transmits 322 at least one of the plurality of second signals to the at least one tank entry valves to close the at least one tank entry valve. After transmitting 322 one of the plurality of second signals to close the at least one tank entry valve, the system, in an example embodiment, sounding 324 at least one alarm where the alarm may be at least one of an auditory alarm and a visual alarm indicator in the remote device. The at least one processor may transmit one of the plurality of second signals to at least one of a speaker and the remote device. Closing, in step 322, the at least one tank entry valve will prevent water, wastewater, and matter from entering at least one of the blackwater holding tank and the greywater holding tank and will prevent at least one of the blackwater holding tank and greywater holding tank from filling past the respective first predetermined maximum threshold and second predetermined maximum threshold which may prevent overfilling of the blackwater holding tank and greywater holding tank.

If the at least one processor does not determine 316 that the first volume of blackwater exceeds a first predetermined maximum threshold, then monitoring (326 in FIG. 3C) the egress conduit attachment to the sewer system. If the at least one processor does not determine 320 that the second volume of blackwater exceeds a second predetermined maximum threshold, then monitoring (326 in FIG. 3C) the egress conduit attachment to the sewer system.

Referring now to FIG. 3C, a block diagram illustrating the exemplary method 300 for the automatic management of wastewater and freshwater for recreational vehicles, namely, monitoring the egress conduit and determining if it is attached to a sewer system is shown, according to an example embodiment. The egress conduit sensor is configured for monitoring 326 the egress conduit sensor's attachment to the sewer system. The egress conduit sensor continuously monitors 326 the attachment to the sewer system and transmits one of the plurality of first signals to the at least one processor. The at least one processor receives one of the plurality of first signals from the egress conduit sensor and if the at least one processor determines 328 that the egress conduit is not attached to the sewer system, then continuing monitoring (314 in FIG. 3B) the first volume of blackwater and monitoring (318 in FIG. 3B) the second volume of greywater. If the at least one processor determines 328 that the egress conduit is attached to the sewer system, then determining 330 if the automatic dump function is enabled. If the at least one processor determines that the automatic dump function is not enabled, then continuously monitoring (314 in FIG. 3B) the first volume of blackwater and monitoring (318 in FIG. 3B) the second volume of greywater. If the at least one processor determines that the automatic dump function is enabled, then executing the automatic dump function of FIG. 3D.

Referring now to FIG. 3D, a block diagram illustrating the exemplary method 300 for the automatic management of wastewater and freshwater for recreational vehicles, namely, executing the automatic dump function is shown, according to an example embodiment. If the at least one processor determines (330 in FIG. 3C) that the automatic dump function is enabled, then transmitting 332 at least one of the plurality of second signals to the tank drain valve and the spray nozzle valve where the at least one of the plurality of second signals is configured for opening 332 the at least one tank drain valve and the spray nozzle valve. The at least one processor is configured for transmitting, to the spray nozzle valve, one of the plurality of second signals to open the spray nozzle valve when the at least one processor opens the at least one tank drain valve. In other embodiments where the system does not include a spray nozzle valve, then opening the at least one tank entry valve. Once the at least one tank drain valve is open, blackwater drains from the blackwater holding tank and greywater drains from the greywater holding tank into the egress conduit and out of the system into the sewage system. To facilitate draining the blackwater from the blackwater holding tank and the greywater from the greywater holding tank, the spray nozzle is configured for spraying 334 high pressurized water on the interior walls of at least the blackwater holding tank and greywater holding tank. Spraying 334 cleans the backwater holding tank by washing blackwater from the walls of the blackwater holding tank and cleans the greywater holding tank by washing greywater from the walls of the greywater holding tank.

As the blackwater from the blackwater holding tank drains, the blackwater sensor monitors 336 the first volume of blackwater within the blackwater holding tank. As the greywater from the greywater holding tank drains, the greywater sensor monitors 336 the second volume of greywater. The blackwater sensor and greywater sensor each continuously transmit one of the first signals to the at least one processor. The at least one processor is further configured for determining 338 whether at least one of the first volume of blackwater and second volume of greywater reached a first minimum threshold. In one embodiment, determining 338 both the first volume of blackwater and the second volume of greywater must reach the first minimum threshold. Generally, the first minimum threshold of each of the blackwater holding tank and greywater holding tank is when each respective tank is empty (or 0% percent of grey water or black water by volume) and does not contain blackwater and greywater. If the at least one processor determines that the at least one of the first volume of blackwater and second volume of greywater did not reach the first minimum threshold, then continuously monitoring 336 at least one of the first volume of blackwater and second volume of greywater until the condition of step 338 is satisfied and the gray water tank and black water tanks are empty.

When the at least one processor determines that that at least one of the first volume of blackwater and second volume of greywater reaches the first minimum threshold, then transmitting 340 one of the plurality of second signals to the at least one tank drain valve. The at least one processor is configured for transmitting one of the plurality of second signals to the at least one tank drain valve where the one of the plurality of second signals is configured to close, at step 340, the at least one tank drain valve. Transmitting 340, to the at least one tank drain valve, one of the plurality of second signals to close the at least one tank drain valve when the at least one processor determines that at least one of the first volume of blackwater and second volume of greywater reaches a first minimum threshold. In other embodiments, there may be two tank drain valves where each of the blackwater holding tank and greywater holding tank is connected to a separate tank drain valve; however, both tank drain valves are still connected to the egress conduit. Such an embodiment may allow the user to automatically control each of the blackwater holding tanks and greywater holding tanks separately.

When the at least one tank drain valve is closed, filling 342 at least one of the blackwater holding tank and greywater holding tank with a third volume of water supply. This third volume is similar to the wash down phase to clean any remaining unwanted items that may be stuck to the inside portions of the tanks. The third volume of water supply can be filled using a water source having the water enter the blackwater holding tank and greywater holding tank through the at least one tank entry valve, which may include the spray nozzle valve in other embodiments. Each of the blackwater sensor and greywater sensor is further configured for monitoring 344 the third volume of water supply within the blackwater holding tank and greywater holding tank, respectively. In other embodiments, at least one additional sensor may be in attachment with at least one of the blackwater holding tank and greywater holding tank to monitor the third volume of water. The system continues to fill at least one of the blackwater holding tank and greywater holding tank until the third volume of water supply reaches a third predetermined maximum threshold. The blackwater sensor and greywater sensor continuously transmit one of the plurality of first signals to the at least one processor having information about the third volume of water supply.

The at least one processor is then configured for determining 346 whether the third volume of water supply reached a third maximum predetermined threshold in at least one of the blackwater holding tank and greywater holding tank. In one embodiment, the third predetermined maximum threshold is seventy-five percent (75%) of the total volume of each of the blackwater holding tank and greywater holding tank. In other embodiments, the third predetermined maximum threshold may be different in the blackwater holding tank than in the greywater holding tank depending on the volume of each holding tank. In other embodiments, the third predetermined maximum threshold is adjustable by the user. If the at least one processor determines 346 that that third volume of water supply did not reach the third predetermined maximum threshold, then continuing to monitor 344 the third volume of water supply as the water supply is filling at least one of the blackwater holding tank and greywater holding tank. If the at least one processor determines 346 that that third volume of water supply did reach the third predetermined maximum threshold, then transmitting 348 one of the plurality of second signals to the at least one tank entry valve where the one of the second signals is configured to close the at least one tank entry valve. In the example embodiment, the at least one processor transmits one of the plurality of second signals to the spray nozzle valve to close 348 the at least one spray nozzle valve. This may stop the third volume of water supply from filling the tank exceedingly past the third predetermined maximum threshold. In another embodiment, the processor is configured for transmitting, to the water supply valve, one of the plurality of second signals to close the spray nozzle valve and open the at least one tank drain valve when the processor determines that at a third volume of water supply exceeds a third predetermined maximum threshold in at least one of the blackwater holding tank and the greywater holding tank.

The at least one processor then transmits one of the plurality of second signals to the at least one tank drain valve. The one of the plurality of second signals is configured for opening 350 the at least one tank drain valve. Steps 342-350 essentially flush the system to ensure all the blackwater and greywater are removed from the system when the blackwater and greywater exceeds the respective predetermined maximum threshold in each of the blackwater holding tank and greywater holding tank. Therefore, the third volume of water supply in at least one of the blackwater holding tank and greywater holding tank starts to drain from its respective holding tank. The blackwater sensor and greywater sensor will monitor 352 the third volume of water supply as it drains from its respective holding tank and each of the blackwater sensor and greywater sensor will continuously transmit to the at least one processor. The at least one processor will then determine 354 whether the third volume of water supply reached the second minimum threshold (generally empty or zero volume) in at least one of the blackwater holding tank and greywater holding tank. The second minimum threshold is generally equivalent to the third volume of water supply being empty or substantially drained from its respective holding tank. The system continues to monitor 352 until the third volume of water supply reaches the second minimum threshold. When the third volume of water supply reaches the second minimum threshold, then the at least one processor transmits 356 one of the plurality of second signals to the at least one tank drain valve. The at least one processor is configured for transmitting, to the at least one tank drain valve, one of the plurality of second signals to close 356 the at least one tank drain valve when the at least one processor determines that the third volume of water supply reaches a second minimum threshold in at least one of the blackwater holding tank and greywater holding tank. The at least one processor will also revert to the initial stem of method 300 to monitor (302 in FIG. 3A) the emergency stop button.

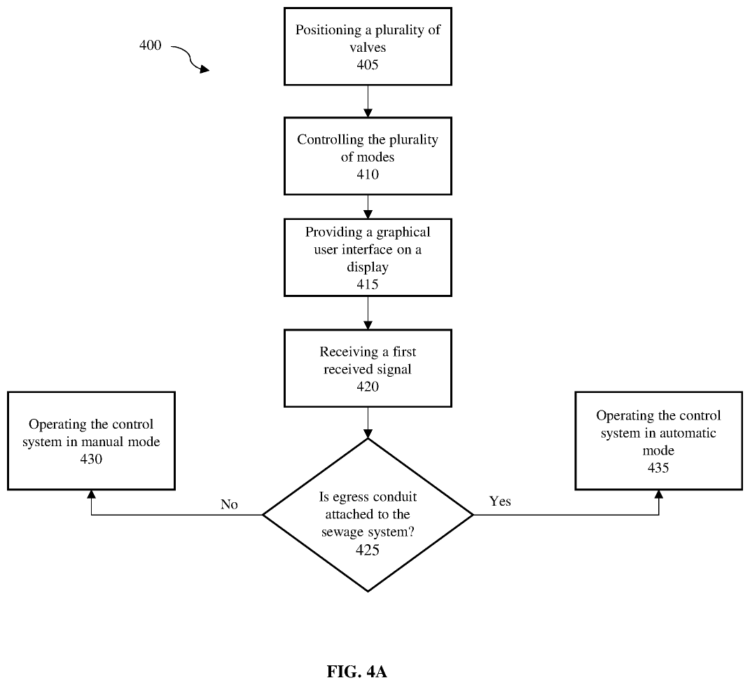

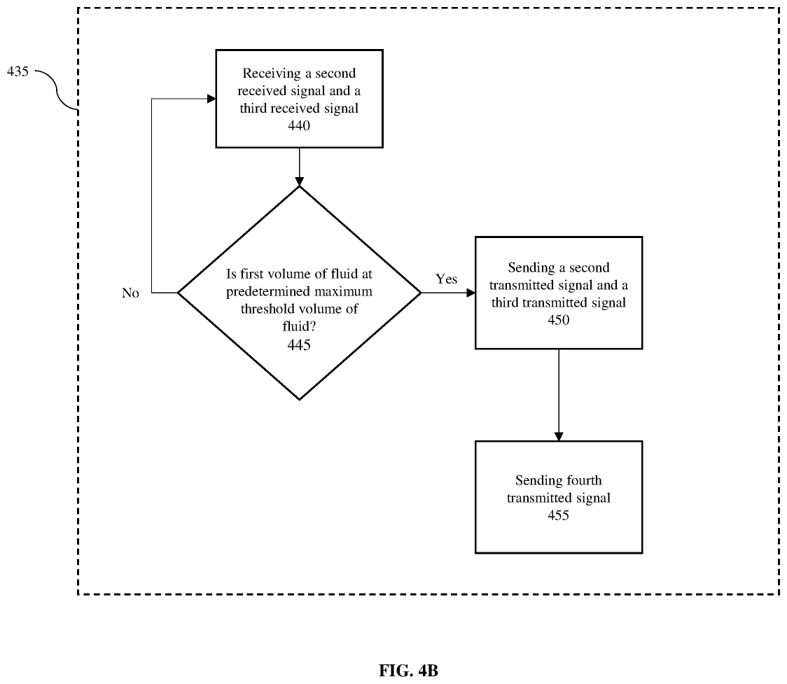

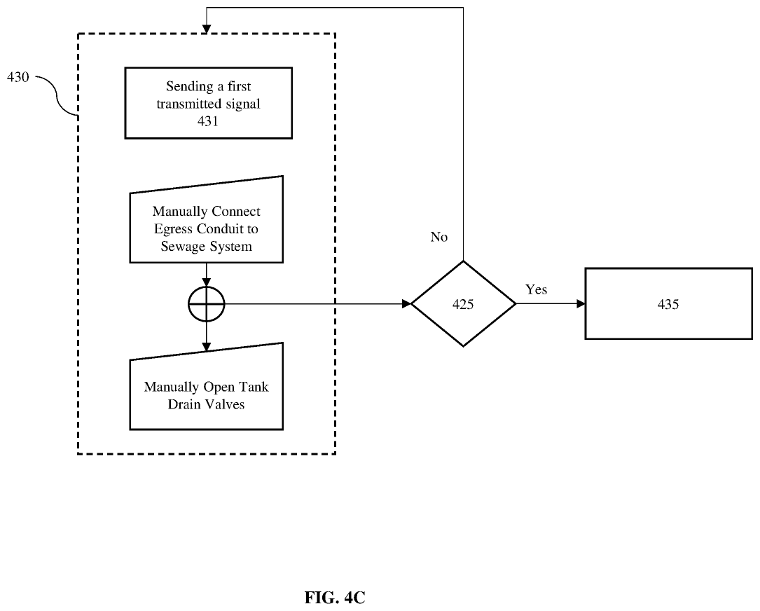

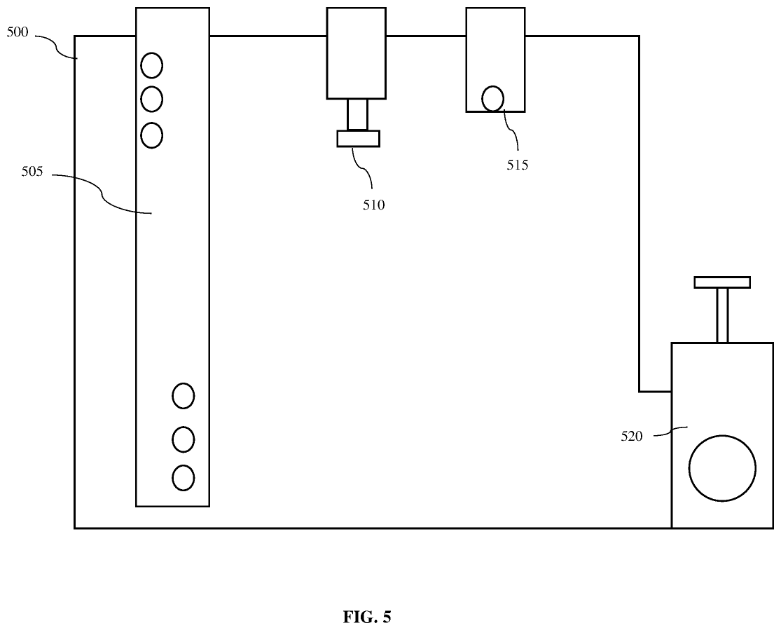

Referring now to FIGS. 4A-4C and FIG. 5, the method for managing wastewater and freshwater for recreational vehicles will be described. FIG. 4A illustrates a method for the automatic management of wastewater and freshwater for recreational vehicles, according to an example embodiment. FIG. 4B illustrates a method for the automatic mode, according to an example embodiment. FIG. 4C illustrates a method for the manual mode, according to an example embodiment. FIG. 5 is a side view of a holding tank used for the blackwater holding tank and the greywater holding tank, according to an example embodiment. In step 405, a user of the system 200 positions a plurality of valves through at least one of a plurality of modes of operation including a manual mode and an automatic mode. The plurality of valves may include tank entry valves, water supply valves, and tank drain valves. In step 410, the user controls the plurality of modes from a control system to transition between the plurality of modes of operation. The control system may include a controller that generates control signals to reduce the deviation of the actual value from the desired value to almost zero or lowest possible value. The controller is responsible for the control action of the system to provide accurate output. The controller may include a connected display via Bluetooth® or hard wiring. The display may also be connected to the controller through Wi-Fi, internet connection, or Smart Home integration. The control system may include a power source and a plurality of switches and relays configured to operate the components of the system in accordance with the methods described herein. The controller includes at least one processor configured to send and transmit signals of the system. The control system is configured for receiving information from the valves and sensors, processes said information, and transmits a status indicator for each of the valves and sensors within at least one the greywater holding tank and the blackwater holding tank.

In step 415, the processor provides a graphical user interface on a display. The graphical user interface includes a plurality of status indicators of the plurality of valves, at least one holding tank, and the mode of operation. The graphical user interface further includes a plurality of user interface elements such that the user interacts with the plurality of user interface elements to send a plurality of signals to the plurality of valves in the manual mode. An example of the graphical user interface is illustrated in FIG. 6 and will be discussed below.

In step 420, control system receives, with a processor, from an egress conduit sensor, a first received signal including a connection status of an egress conduit to a sewage system. Shown in FIG. 2, the egress conduit sensor is disposed at an end portion 262 of the egress conduit for detecting if the egress conduit is attached to the sewage system. The graphical user interface may display the connection status for the user by including graphical indicators for the connection status. For example, the graphical user interface may include a label or graphical icon to represent the sewage system. The graphical user interface may further include one of two graphical indicators, a green checkmark to represent that the egress conduit is attached to the sewage system and a red x-shaped symbol to represent that the egress conduit is not attached to the sewage system. The green checkmark or red-shaped symbol may be disposed proximate to the label or graphical icon of the sewage system to indicate to the user that the graphical indicators correspond to the connection status of the sewage system and the egress conduit. The connection status lets the control system and the user know if the sewage system is attached to the egress conduit.

In step 425, the control system uses the processor to determine if the egress conduit is attached to the sewage system based on the first received signal. In step 430, the control system operates in one of the plurality of modes. In step 430, the control system operates in the manual mode if the egress conduit is not attached to the sewage system. In step 431, the control system sends, with the processor, a first transmitted signal to a control valve in fluid communication with a holding tank. The first transmitted signal includes information for closing the control valve. It is important that control valve, which may be at least the tank drain valve, is closed if the egress conduit sensor detects that the egress conduit is not attached to the system so that waste water, such as greywater and/or blackwater, does not expel from the system into the surrounding environment that is not a sewage system. Operating in the manual mode also includes manually connecting the egress conduit to the sewage system. The user may then manually open the tank drain valves or choose to enable automatic mode by interacting with the graphical user interface, which would start step 425 again.

In step 435, the control system operates in the automatic mode if the egress conduit is attached to the sewage system. The control system may display a graphical indicator on the graphical user interface that notifies the user that the control system is in automatic mode. In step 440, the control system receives, with the processor, a second received signal from a blackwater holding tank sensor 505. An example holding tank 500, such as the blackwater holding tank or greywater holding tank, is shown in FIG. 5 having the plurality of sensors. The second received signal includes data related to a first volume of fluid within a holding tank. The control system may additionally receive, with the processor, a third received signal from a greywater holding tank sensor 505, which is shown in FIG. 5. The third received signal includes data related to a first volume of greywater within a greywater holding tank. Then, in step 445, the control system, with the processor, determines if first volume of blackwater within the blackwater holding tank is at a predetermined maximum threshold volume of blackwater based on the second received signal. The control system, with the processor, determines if the first volume of greywater within the greywater holding tank is at a predetermined maximum threshold volume of greywater based on the third received signal.

Additionally, the blackwater holding tank and the greywater holding tank may include a high level float sensor 510 (shown in FIG. 5) that is disposed inside the top of the holding tanks. The high level float sensor acts like a switch that is triggered by the level of the volume of fluid in the holding tanks. If the level of fluid volume in a holding tank reaches the level at which the high level float sensor is disposed, then the high level float sensor sends a signal to the control system indicating that the fluid volume in the holding tank has reached the high level float sensor. In the present disclosure, the high level float sensor 510 allows the control system to know that the fluid inside the holding tank has reached the predetermined threshold.

In step 450, if the first volume of blackwater reaches the first predetermined maximum threshold volume of blackwater, then the control system sends, with the processor, a second transmitted signal to a first control valve 520 in fluid communication with the blackwater holding tank. Additionally, if the first volume of greywater reaches the first predetermined maximum threshold volume of greywater, then the control system sends, with the processor, the second transmitted signal a second control valve 520 in fluid communication with the greywater holding tank. The second transmitted signal includes information for opening each of the first control valve and the second control valve to drain the blackwater and greywater, respectively. The first control valve and the second control valve are open for a first predetermined amount of time to allow the first volume of blackwater to reach a predetermined minimum threshold volume of blackwater within the blackwater holding tank and the first volume of greywater to reach a predetermined minimum threshold volume of greywater within the greywater holding tank. Ideally, the predetermined minimum threshold volumes are zero such that the holding tanks are empty. However, the user may decide to set other volumes to be the predetermined minimum threshold volumes or a range of volume such that the fluid within the respective holding tank is between 0% and 20% total volume. It is understood that any predetermined threshold means that the threshold level or range is may be set by the user and/or manufacturer at a specific amount, period, or time.

Furthermore, if the first volume of blackwater and the second volume greywater reaches the predetermined maximum threshold volumes of blackwater and greywater, respectively, then the control system sends, with the processor, a third transmitted signal to a rinse control unit in fluid communication with a water supply. The third transmitted signal includes opening, for a predetermined period of time, and then closing the water supply valve in fluid communication with the rinse control unit. The rinse control unit includes the spray nozzle 515 (shown in FIG. 5) in fluid communication with the rinse control unit that fills up the holding tank with fresh water. The spray nozzle allows water to spray within the holding tanks to rinse the interior of the holding tanks. Generally, hoses are used to wash the tanks only when the user is flushing the holding tanks. However, in the present embodiment, the system 200 uses the solenoid to allow waterflow through the water supply valve only when the processor 205 deems it safe to operate and automatically controls the water supply valve to allow the tank to be filled to the predetermined maximum threshold volume. The spray nozzle may activate only when the drain valve is closed to prevent wasting fresh water. Once the water level of the holding tanks reaches the predetermined maximum threshold volume, the processor of the remote device prevents the spray nozzle from activating. In other embodiments, the water supply valve may also be open while the drain valve is open such that the spray nozzle rinses the holding tank while the blackwater or greywater is being drained. In such an embodiment, the drain valve may be open until the greywater and/or blackwater is completely drained from the respective holding tank and flushed out of the egress conduit into the sewage system. The rinse control unit, which may include the water supply, the water supply valve, and a spray nozzle, may activate to rinse the respective holding tank while the tank is draining. The spray nozzle rinses sides of the holding tank with clean or fresh water and may also spray down or clean the sensors within the holding tank. In certain embodiments, the drain valve may close after the holding tank is completely emptied or after a predetermined amount of time, such as two (2) minutes for example. The rinse control unit may still be turned on (i.e., water supply valve and/or tank entry valve is open) such that the water is supplied to be sprayed by the nozzle for an additional period of time after the drain valve is closed. This may allow a small amount of freshwater, such as 5% to 20% volume of the holding tank to be occupied by clean water. The period of time is such that until the tank fills up with the predetermined amount of fresh water. Filling the holding tank with an additional amount of fresh water after flushing may allow new blackwater or greywater (which may contain waste and dirt) to float or reside within the clean water instead of sticking to the sides of the holding tank. Moreover, the water may dilute the contaminated blackwater or greywater as to mask any odors. This facilitates further rinsing cycles to keep a clean holding tank and an odor free recreational vehicle.

In step 455, the control system sends, with the processor, a fourth transmitted signal to the control valve. The fourth transmitted signal includes closing the control valve after a another predetermined period of time. As exampled above, the water supply valve may be opened for a first predetermined amount of time whereas the control valve may be open for a second predetermined amount of time. Ideally, the first predetermined amount of time that the water supply is open is greater than the second predetermined amount of time that the control valve is open. This allows for the simultaneous rinse as described above. In other embodiments, the water supply valve may be opened when—as being before, simultaneous to, or after—the control valve is open. Moreover, the water supply valve is generally closed simultaneous to or after the control valve is closed.

It is understood that this method is a continuous cycle and that each step of method 400 may operate concurrently with another step of method 400 to provide a continuous movement and introduction of tempered and dehumidified air within the system. In other embodiments, the method may further include additional steps to promote automatic management of wastewater and freshwater for recreational vehicles consistent with the systems disclosed herein.

Referring now to FIG. 6, the graphical user interface for the plurality of modes is illustrated, according to an example embodiment. The graphical display data for the user interface may be generated by the at least one processor of the control system. The processor may then transmit the graphical display data to the display or remote controller/computing device. The graphical display data may comprise information for displaying a plurality of user interface elements and indicators. Such user interface elements and indicators may correspond to each of the of the method steps described herein. The indicators may include digital indicators, such as icons, displayed from the graphical display data, or, in certain embodiments, the graphical display data may comprise information for triggering a switch, or a plurality of switches, to turn on a light, such as a light emitting diode, in electrical communication with at least one of the processor of the control system or the processor of the remote controller/computing device. It is understood that in embodiments where a remote computing device is used, the control system transmits, with the processor over a communications network, such as via Wi-Fi, Bluetooth®, internet connection, or Smart Home integration, for example, to a remote computing device, such as cellular device or other computer having an independent processor and a display, the graphical display data for displaying the user interface. An example user interface that may be displayed on a connected display of the control system or a display of a remote computing device is shown in FIG. 6 and further detailed below. The display connected to the control system and/or the display of the remote computing device may be a touch screen display configured to receive an manual input by the user interacting with one of the plurality of user interface elements. Upon interacting, such as selecting, inputting, or gesturing with the user interface, at least one of the processors (of the control system or the processor of the independent computing device) will transmit to the central processor of the control system, information (such as a data packet comprising the input information, or an electrical signal) so that the central processor may execute one of a plurality of functions and methods disposed herein. Gesturing may include computer gestures such as a tap, via a touch sensitive interface display, a click, on or near one of the second user graphical indicators. For example, although the system may automatically preform the method steps herein upon connection of the egress conduit, if the user selects, for example, “turn rinse water on”, the processor may execute functions necessary to perform the method steps of steps 332 through 354 to execute a flush and rinse. Such interactions with the user interface may enable the system to perform methods disclosed herein independent from the entire method at any time.

The graphical user interface is configured to allow the user to interact with the interface, and/or webpage, such that the interface(s) and display(s) includes the plurality of user interface elements such as input controls, navigation components, informational components, and containers. Such user interface elements may include for example, accordions, bento menu(s), breadcrumb(s), button(s), card(s), carousel(s), check box(es), comment(s), doner menu(s), dropdown(s), feed(s), form(s), hamburger menu(s), icon(s), input field(s), kebab menu(s), loader(s), meatball menu(s), modal(s), notification(s), pagination(s), picker(s), progress bar(s), radio button(s), search field(s), sidebar(s), slide control(s), stepper(s), tag(s), tab bar(s), tool tip(s), and toggle(s). Each of these user interface elements may be used in certain embodiments to enable each of the users to interact with the system, provide data to and from the remote device 115 across the network 105 and implement the methods as discussed in FIGS. 3A through 4C. Other user interface elements configured to provide a display to the user to interact with the system in accordance with the methods described herein may be used and are within the spirit and scope of the disclosure. The graphical user interface may include the blackwater volume level 602 in the blackwater holding tank and the greywater volume level 604 in the greywater holding tank. The blackwater volume level and the greywater volume level may be represented by gauges 606. In other embodiments, the graphical user interface may display the percentage number of the levels within the holding tanks. The gauges may include a plurality of shades 615 to indicate ranges that help the user determine whether the volume levels are low or high. The graphical user interface may also include an alarm 608 for each of the blackwater volume and greywater volume levels. The alarm may display at least one of a no alarm condition 609 and a high level condition 611. The no alarm condition may be displayed when the volume level is below the predetermined maximum threshold volume, and the high level condition may be displayed when the volume level within a range that includes the predetermined maximum threshold 609. When the volume levels reach the predetermined maximum threshold, the remote device may emit a sound that alerts the user that the volume levels are high. The alarm may also include a warning alarm to be display when the volume levels begin reaching the predetermined maximum threshold. The alarm may also display an empty condition that is displayed when the volume levels reach the predetermined minimum threshold volume 607. The graphical user interface may include a button for enabling 610 automatic mode and a button for disabling 612 automatic mode. The buttons may be interacting with by a gesture to send a signal to the control system. As previously described, the graphical user interface may include a connection status 614 for the sewage system to notify the user whether or not the egress conduit is attached to the sewage system.

The graphical user interface may also include a button for opening 616 and a button for closing 618 the control valve of the blackwater tank. Additionally, graphical user interface may include a button for opening 620 and a button for closing 622 the control valve of the greywater tank. These buttons allow the user to control whether the tank drain valves in the holding tanks are open or closed. The graphical user interface includes the valve statuses 624 to let the user know whether the tank drain valves in the holding tanks are open 626 or closed 628. The graphical user inter also includes the statuses of the tank rinse on 630, supply closed 632, and the water pump off 634. Each of the statuses may include a graphical icon of a light emitting diode 635. The light emitting diode will emit at least one of a plurality of colors to represent a status. In the present embodiment, the light emitting diode for tank rinse on will emit a green light when the spray nozzle is rinsing the holding tanks and a red light if the spray nozzle is not rinsing the holding tanks. The light emitting diode for the supply closed will emit a green light if the water supply valve is closed and a red light if the water supply valve is open. The light emitting diode will emit a green light if the water pump is on and a red light if the water pump is off. In other embodiments, the light emitting diode may emit other shades of colors that are within the spirit and scope of the present disclosure. The graphical user interface may also include buttons that control the water supply. For example, the graphical may include a button for turning on the spray nozzle 636, turning off the spray nozzle 638, opening up the water supply valve 640, initiating a quick dump and flush 642, and turning on the water pump 644.

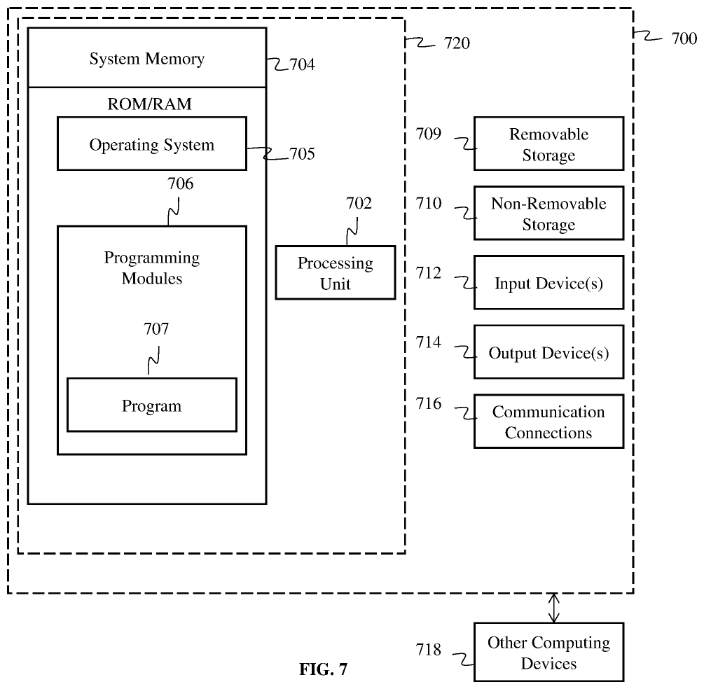

Referring now to FIG. 7, a block diagram of a system including an example computing device 700 and other computing devices. Consistent with the embodiments described herein, the aforementioned actions performed by system 200 may be implemented in a computing device, such as at least one processor 205. Any suitable combination of hardware, software, or firmware may be used to implement at least one processor 205. The aforementioned system, device, and processors are examples and other systems, devices, and processors may comprise the aforementioned computing device. Furthermore, at least one processor 205 may comprise an operating environment for system 200. Processes, data related to system 200 may operate in other environments and are not limited to processor 205.

A system consistent with an embodiment of the disclosure may include a plurality of computing devices, such as a computing device 700 of FIG. 7. In a basic configuration, computing device 700 may include at least one processing unit 702 and a system memory 704. Depending on the configuration and type of computing device, system memory 704 may comprise, but is not limited to, volatile (e.g., random access memory (RAM)), non-volatile (e.g., read-only memory (ROM)), flash memory, or any combination or memory. System memory 704 may include operating system 702, and one or more programming modules 706. Operating system 702, for example, may be suitable for controlling computing device 700′s operation. In one embodiment, programming modules 706 may include, for example, a program module 707 for executing the actions illustrated in the methods 300 and 400 of FIG. 3A-4C, execute any of the actions of the function of the components illustrated in system 200 of FIG. 2. For example. Furthermore, embodiments of the disclosure may be practiced in conjunction with a graphics library, other operating systems, or any other application program and is not limited to any particular application or system. This basic configuration is illustrated in FIG. 7 by those components within a dashed line 720.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable, and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 700. Any such computer storage media may be part of system 700. Computing device 700 may also have input device(s) 712 such as a keyboard, a mouse, a pen, a sound input device, a camera, a touch input device, etc. Output device(s) 714 such as a display, speakers, a printer, etc. may also be included. The aforementioned devices are only examples, and other devices may be added or substituted.

Computing device 700 may also contain a communication connection 716 that may allow system 200 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, several program modules and data files may be stored in system memory 704, including operating system 702. While executing on processing unit 702, programming modules 706 (e.g., program module 707) may perform processes including, for example, one or more of the stages of a process. The aforementioned processes are examples, and processing unit 702 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. It is also understood that components of the system may be interchangeable or modular so that the components may be easily changed or supplemented with additional or alternative components.

While certain embodiments of the disclosure have been described, other embodiments may exist. Furthermore, although embodiments of the present disclosure have been described as associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the disclosure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system for automatic management of wastewater and freshwater for recreational vehicles, the system comprising:
a. a blackwater holding tank having a blackwater inlet, and a blackwater egress;
b. a blackwater sensor configured for monitoring a first volume of blackwater within the blackwater holding tank;
c. a greywater holding tank having a greywater inlet, and a greywater egress;
d. a greywater sensor configured for monitoring a second volume of greywater within the greywater holding tank;
e. at least one tank entry valve in fluid communication with the blackwater inlet and the greywater inlet;
f. at least one tank drain valve in fluid communication with the blackwater egress and the greywater egress;
g. an egress conduit in fluid communication with the at least one tank drain valve;
h. an egress conduit sensor for detecting if the egress conduit is attached to a sewage system;
i. at least one processor configured for receiving a plurality of first signals from the blackwater sensor, the greywater sensor, and the egress conduit sensor and transmitting a plurality of second signals to the at least one tank entry valve and the at least one tank drain valve, and the wherein the at least one processor is configured for:
i. determining if at least one of (1) the first volume of blackwater exceeds a first predetermined maximum threshold and (2) if the second volume of greywater exceeds a second predetermined maximum threshold;
ii. transmitting, when the at least one processor determines that at least one of (1) the first volume of blackwater exceeds the first predetermined maximum threshold and (2) the second volume of greywater exceeds the second predetermined maximum threshold, one of the plurality of second signals to the at least one tank entry valve to close the at least one tank entry valve;
iii. determining if the egress conduit is attached to the sewage system; and
iv. transmitting, when the at least one processor determines that the egress conduit is attached to the sewage system, one of the plurality of second signals to the at least one tank drain valve to open the at least one tank drain valve.

2. The system of claim 1 where the system further comprises:
a. a water supply in fluid communication with at least one of the blackwater holding tank and the greywater holding tank; and
b. at least one spray nozzle disposed within at least one of the blackwater holding tank and the greywater holding tank.

3. The system of claim 2 where the at least one tank entry valve comprises:
a. a water supply valve in fluid communication with the water supply configured for controlling the water from the water supply into at least one of the blackwater holding tank and the greywater holding tank; and
b. a spray nozzle valve in fluid communication with the water supply and the at least one spray nozzle configured for controlling high pressurized water spraying from the at least one spray nozzle.

4. The system of claim 3, where the at least one processor is further configured for at least one of:
a. transmitting, to the at least one tank drain valve, one of the plurality of second signals to close the at least one tank drain valve when the at least one processor determines at least one of (1) that at least one of (i) the first volume of blackwater and (ii) second volume of greywater reaches a first minimum threshold, and (2) that the at least one tank drain valve has been open for a first predetermined amount of time;
b. transmitting, to the spray nozzle valve, one of the plurality of second signals to open the spray nozzle valve when the at least one processor closes the at least one tank drain valve;
c. transmitting, to the water supply valve and the at least one tank drain valve, one of the plurality of second signals to close the spray nozzle valve and open the at least one tank drain valve when the at least one processor determines that at a third volume of water supply exceeds a third predetermined maximum threshold in at least one of the blackwater holding tank and the greywater holding tank; and
d. transmitting, to the at least one tank drain valve, one of the plurality of second signals to close the at least one tank drain valve when the at least one processor determines that the third volume of water supply reaches a second minimum threshold in at least one of the blackwater holding tank and the greywater holding tank.

5. The system of claim 1, comprising a power source, a display, and at least one valve actuator.

6. The system of claim 1, wherein the egress conduit sensor is a magnetic contact sensor.

7. The system of claim 1, wherein the at least one tank entry valve comprises one of a magnetic solenoid and an electric ball valve and the least one tank drain valve comprises a linear type actuator.

8. The system of claim 1, wherein the system is configured to receive a third signal from a remote device configured to cause the at least one processor to transmit at least one of the plurality of second signals.

9. The system of claim 8, wherein the remote device is at least one of a voice activated remote controlling device and a smart home system.

10. The system of claim 8, wherein the remote device is a programmable logic controller.

11. A method for managing wastewater and freshwater for recreational vehicles, the method comprising:
a) positioning a plurality of valves through at least one of a plurality of modes of operation including a manual mode and an automatic mode; and
b) controlling the plurality of modes from a control system to transition between the plurality of modes of operation.

12. The method of claim 11, further comprising providing a graphical user interface on a display, wherein the graphical user interface comprises a plurality of status indicators of the plurality of valves, at least one holding tank, and the mode of operation of the plurality of modes.

13. The method of claim 12, wherein the graphical user interface comprises a plurality of user interface elements such that the user interacts with the plurality of user interface elements to send a plurality of signals to the plurality of valves in the manual mode.

14. The method of claim 11 further comprising:
a) receiving, with a processor of the control system, from an egress conduit sensor, a first received signal comprising a connection status of an egress conduit to a sewage system, wherein the egress conduit sensor is disposed at an end portion of the egress conduit for detecting if the egress conduit is attached to the sewage system;
b) determining with the processor, based on the first received signal, if the egress conduit is attached to the sewage system; and
c) operating the control system in one of the plurality of modes, where in the control system operates in the manual mode if the egress conduit is not attached to the sewage system, and in the automatic mode if the egress conduit is attached to the sewage system.

15. The system of claim 14, wherein if the egress conduit is not attached to the sewage system, then sending, with the processor, a first transmitted signal to a control valve in fluid communication with a holding tank, wherein the first transmitted signal comprises information for closing the control valve.

16. The system of claim 14, wherein the automatic mode comprises:
a) receiving, with the processor of the control system, from a holding tank sensor, a second received signal comprising data related to a first volume of fluid within a holding tank, wherein the holding tank sensor is disposed within the holding tank for monitoring the first volume of fluid;
b) determining with the processor, based on the second received signal, if the first volume of fluid within the holding tank is at a predetermined maximum threshold volume of fluid; and
c) if the first volume of fluid reaches the predetermined maximum threshold volume of fluid then sending, with the processor, a second transmitted signal to a control valve in fluid communication with the holding tank, wherein the second transmitted signal comprises information for opening the control valve.

17. The system of claim 16, wherein the automatic mode further comprises:
sending, with the processor, a third transmitted signal to a rinse control unit in fluid communication with a water supply, wherein the third transmitted signal comprises opening, for a first predetermined period of time then closing, a water supply valve in fluid communication with the rinse control unit.

18. The system of claim 17, wherein the control valve is a drain valve in fluid communication with the holding tank and the egress conduit, and wherein the automatic mode further comprises:
sending, with the processor, a fourth transmitted signal to the control valve, wherein the fourth transmitted signal comprises closing the control valve after second predetermined period of time, and wherein the first predetermined period of time is greater than the second predetermined period of time.

19. A method for managing wastewater and freshwater for recreational vehicles, the method comprising:
a) positioning a plurality of valves through at least one of a plurality of modes of operation including a manual mode and an automatic mode;
b) controlling the plurality of modes from a control system to transition between the plurality of modes of operation;
c) receiving, with a processor of the control system, from an egress conduit sensor, a first received signal comprising a connection status of an egress conduit to a sewage system, wherein the egress conduit sensor is disposed at an end portion of the egress conduit for detecting if the egress conduit is attached to the sewage system;
d) determining with the processor, based on the first received signal, if the egress conduit is attached to the sewage system; and
e) operating the control system in one of the plurality of modes, where in the control system operates in the manual mode if the egress conduit is not attached to the sewage system, and in the automatic mode if the egress conduit is attached to the sewage system.

20. The method of claim 19, wherein the automatic mode comprises:
a) receiving, with the processor of the control system, from a blackwater holding tank sensor, a second received signal comprising data related to a first volume of blackwater within a blackwater holding tank, wherein the blackwater holding tank sensor is disposed within the blackwater holding tank for monitoring the first volume of blackwater;
b) determining with the processor, based on the second received signal, if the first volume of blackwater within the blackwater holding tank is at a first predetermined maximum threshold volume of blackwater;
c) receiving, with the processor of the control system, from a greywater holding tank sensor, a third received signal comprising data related to a first volume of greywater within a greywater holding tank, wherein the greywater holding tank sensor is disposed within the greywater holding tank for monitoring the first volume of greywater;
d) determining with the processor, based on the third received signal, if the first volume of greywater within the greywater holding tank is at a first predetermined maximum threshold volume of greywater
e) if the first volume of blackwater reaches the first predetermined maximum threshold volume of blackwater and the first volume of greywater reaches the first predetermined maximum threshold volume of greywater, then sending, with the processor, a second transmitted signal to a first control valve in fluid communication with the blackwater holding tank and a second control valve in fluid communication with the greywater holding tank, wherein the second transmitted signal comprises information for opening each of the first control valve and the second control valve;
f) wherein the first control valve and the second control valve are open for a first predetermined amount of time; and
g) sending, with the processor, a third transmitted signal to a rinse control unit in fluid communication with a water supply disposed within at least one of the greywater holding tank and the blackwater holding tank, wherein the third transmitted signal comprises opening, for a second predetermined amount of time then closing, a water supply valve in fluid communication with the rinse control unit.
